(19) United States
(12) Patent Application Publication
(10) Pub. No.: US 2026/0145805 A1
(43) Pub. Date: May 28, 2026

(54) AIRSPEED DEPENDENT LIFT PROPELLER SPEED LIMIT

(71) Applicant: BETA AIR LLC, South Burlington, VT (US)

(72) Inventor: Nicholas Moy, South Burlington, VT (US)

(21) Appl. No.: 19/402,098

(22) Filed: Nov. 26, 2025

Related U.S. Application Data
(60) Provisional application No. 63/726,128, filed on Nov. 27, 2024.

(51) Int. Cl. B64D 31/16; B64C 29/00; H02P 5/48

(52) U.S. Cl. CPC B64D 31/16; B64C 29/00; H02P 5/48

(57) ABSTRACT

A system for flight control in electric aircraft includes a flight controller configured to provide an initial vehicle torque signal including a plurality of attitude commands. The system includes a mixer configured to receive the initial vehicle torque signal and a vehicle torque limit, receive an airspeed-based RPM limit, determine a plurality of modified attitude commands as a function of the vehicle torque limit, the attitude commands, and the airspeed-based RPM limit, generate, as a function of modified attitude commands, an output torque command including the initial vehicle torque signal adjusted as a function of the vehicle torque limit, generate, as a function of the output torque command, a remaining vehicle torque. The system includes a display, wherein the display is configured to present, to a user, the remaining vehicle torque and the output torque command.

### RELATED APPLICATIONS

This application claims priority to U.S. Provisional Ser. No. 63/726,128, filed Nov. 27, 2024, titled “AIRSPEED DEPENDENT LIFT PROPELLER SPEED LIMIT,” the entirety of which is incorporated herein by reference.

### BACKGROUND

The burgeoning of electric vertical take-off and landing (eVTOL) aircraft technologies promises an unprecedented forward leap in energy efficiency, cost savings, and the potential of future autonomous and unmanned aircraft. However, the technology of eVTOL aircraft is still lacking in crucial areas of control. This is particularly problematic as it compounds the already daunting challenges to designers and manufacturers developing the aircraft for manned and/or unmanned flight in the real world.

### SUMMARY

In an aspect of the present disclosure, a system for flight control in an aircraft includes a vehicle attitude controller configured to determine commands for a plurality of propulsors, the commands including a command for each propulsor of the plurality of propulsors. The system includes a mixer configured to determine an airspeed associated with the aircraft, determine an RPM limit based at least in part on the airspeed, calculate adjusted motor commands for the plurality of propulsors based at least in part on the RPM limit, and transmit the adjusted motor commands to the corresponding propulsors of the plurality of propulsors.

In another aspect of the present disclosure, a method for flight control in an aircraft includes receiving the determined vehicle body torque or acceleration, receiving airspeed-based RPM limits associated with the electric aircraft, and determining an adjusted output torque command based at least in part on the airspeed-based RPM limit.

In yet another aspect of the present disclosure, an aircraft includes a vehicle attitude controller configured to determine a vehicle body torque or acceleration and a mixer. The mixer may be configured to receive the determined vehicle body torque or acceleration; receive airspeed-based RPM limits associated with the electric aircraft, and determine an adjusted output torque command based at least in part on the airspeed-based RPM limit.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF DRAWINGS

FIG. 1 is a schematic view of an example electric vertical takeoff and landing (eVTOL) aircraft, according to examples of the disclosure.

FIG. 2 is a block diagram of an example architecture of a system of an aircraft, according to examples of the disclosure.

FIG. 3 is an example chart depicting a plot of lift rotor RPMs during a simulation in which an airspeed-based RPM limit is imposed, according to examples of the disclosure.

FIG. 4 is an example operating envelope usable by an aircraft, according to examples of the disclosure.

FIG. 5 is a flow diagram depicting an example method for utilizing an airspeed-based RPM limit for generating motor commands usable by aircraft, according to examples of the disclosure.

FIG. 6 is a flow diagram depicting an example method for utilizing an airspeed-based RPM limit for generating motor commands usable by aircraft, according to examples of the disclosure.

FIG. 7 is a block diagram of a controller of an aircraft, according to examples of the disclosure.

### DETAILED DESCRIPTION

Wherever possible, the same reference numbers will be used throughout the drawings to refer to the same or like parts.

The disclosure herein is directed to systems, methods, and apparatus for determining revolution-per-minute (RPM) limits for an aircraft based on an airspeed and/or utilizing an airspeed-based RPM limit for generating motor commands, such as, but not limited to, a torque command. In examples of the disclosure, the aircraft may include an electric vertical takeoff and landing (eVTOL) aircraft. Although disclosed in the context of an eVTOL aircraft, it should be understood that the disclosure herein may be applied to any situation in which it is desired to adjust an RPM limit for a motor based on an increased load experienced by the aircraft. For example, a mixer in an attitude controller may utilize an RPM limit, as well as other data, when generating and outputting motor commands. Particularly in aircraft utilizing fixed pitch lift propellers that do not have cyclic or collective blade pitch control, increased differential loads may be experienced on blades of the propeller. Excessive load on the blades of the propeller as well as other portions of the aircraft may cause damage to the aircraft resulting in unsafe flying conditions. In some cases, an operating envelope for a motor of the aircraft may be generated that indicates airspeed-based RPM limits that allow for the aircraft to perform reasonably aggressive transitions (e.g., transitioning from vertical to forward flight) without causing unsafe load to be experienced by the aircraft. The RPM limits discussed herein may refer to limits on the RPM of individual propulsors (e.g., rotors) used by an aircraft to operate.

In some cases, the attitude controller of the aircraft may translate a pilot's input to one or more torque commands needed at lift propulsors to achieve the desired aircraft attitude change. In this case, the RPM limit may be included as a constraint when generating the torque command (or other motor commands). For example, the system may determine an aggregate torque and/or or acceleration that the entire aircraft should experience and then determine a motor torque command for each motor in order to not exceed the aggregate torque and/or acceleration. A mixer may utilize different types of data (e.g., power limits, motor limits, battery power, torque limits, RPM limits, etc.) as constraints when calculating the torque commands. The mixer may be implemented in a number of different ways and consider multiple types of constraints, such as prioritizing particular maneuvers (e.g., pitch and roll over yaw).

In some examples, the mixer may determine that an input received from a pilot would result in a maneuver that conflicts with one of the constraints (e.g., would exceed battery power, RPM limit, the amount of torque the motor can generate, etc.). In some cases, the mixer may determine a best closest solution and the resulting aggregate aircraft torque commanded at the lift motors may be less than the desired total aircraft torque the mixer received as an input. As an example, the aircraft might not move as quickly or as far in one direction as the pilot wanted because the RPM required to perform the maneuver exceeds the RPM limit.

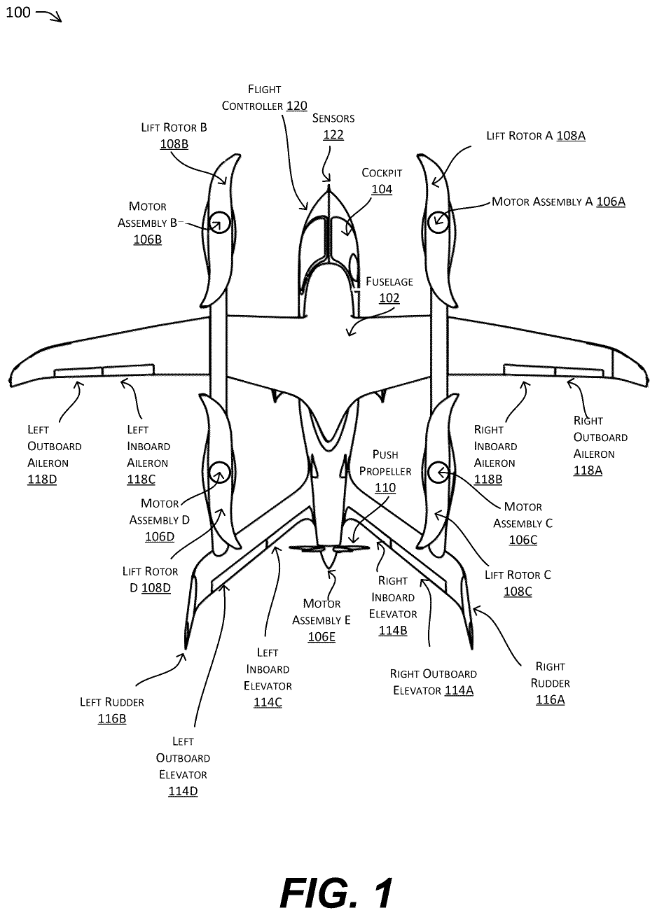

FIG. 1 is a schematic view of an example electric vertical takeoff and landing (eVTOL) aircraft 100, according to examples of the disclosure. The aircraft 100 includes a fuselage 102 and a cockpit 104 to carry passengers and/or a pilot. In alternate cases, the aircraft 100 may be unmanned and controlled remotely. In some cases, the aircraft 100 may have a fly-by-wire control system.

The aircraft 100 may include motor assembly A 106A, motor assembly B 106B, motor assembly C 106C, motor assembly D 106D, and motor assembly E 106E, hereinafter referred to in the singular as motor assembly 106 or in the plural as motor assemblies 106. The motor assemblies 106 may be positioned to balance thrust and/or lift distribution across the aircraft 100. In some embodiments, one or more of the motor assemblies 106 may be configured for redundancy or for failover purposes. For example, in some cases, if motor assembly A 106A were to fail and/or operate at a reduced capacity, a set of other motor assemblies (e.g., motor assembly B 106B, motor assembly C 106C, and/or motor assembly D 106D) may be configured to compensate for the reduced and/or lost operational capacity of motor assembly A 106A.

The motor assemblies 106 may be configured to drive (e.g., rotate) one or more propulsors, such as lift rotors 108A, 108B, 108C, 108D, hereinafter referred to in the singular as lift rotor 108 or in the plural as lift rotors 108, and/or a push propeller 110. For example, motor assembly A 106A may be configured to drive the lift rotor A 108A, motor assembly B 106B may be configured to drive the lift rotor B 108B, motor assembly C 106C may be configured to drive the lift rotor C 108C, motor assembly D 106D may be configured to drive the lift rotor D 108D, and motor assembly E 106E may be configured to drive the push propeller 110. In some examples, lift rotors 108 may be configured to enable the vertical takeoff of the aircraft 100, while the push propeller 110 may be configured to enable the horizontal movement of the aircraft.

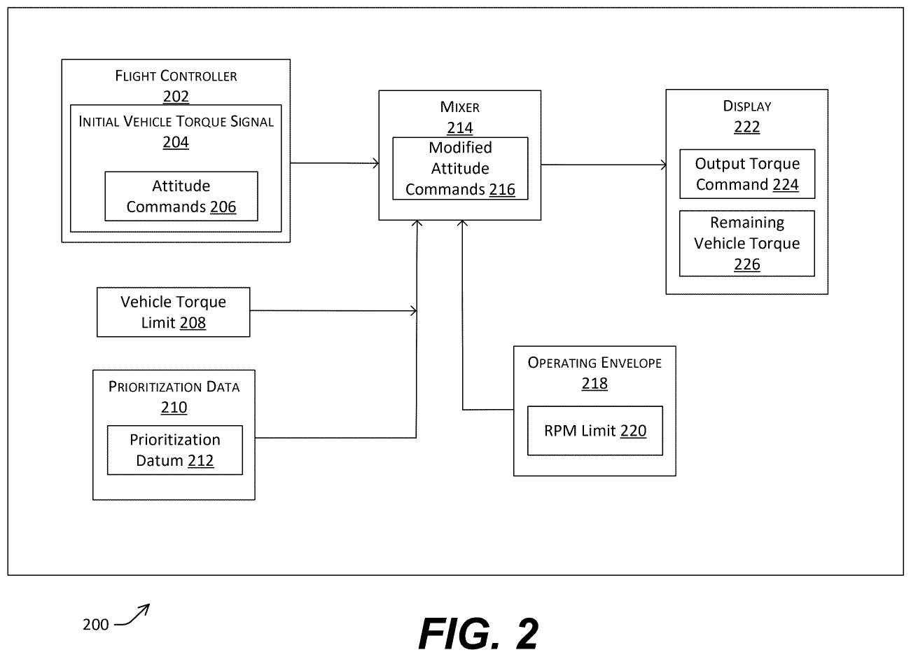

The motor assemblies 106 may include an electric motor and associated hardware and software to control the operation of the motor assemblies 106, as will be discussed in conjunction with FIG. 2. The aircraft 100 may include one or more energy sources such as one or more batteries (not shown) to store electric energy that is used to energize the motor assemblies 106 to drive their corresponding lift rotors 108 and/or push propeller(s) 110. For example, a battery may store electrical energy and provide that energy, as controlled by the components of the motor assembly 106 to provide direct current (DC) electric power to power motors of the motor assemblies 106 to rotate the corresponding lift rotors 108 and/or push propeller 110. The motor assemblies 106 may operate at any suitable voltage, current, and/or power. For example, the motor assemblies may operate in a voltage range of about 25 volts to about 500 volts and a current range of about 10 Amps to about 100 Amps. In some cases, the operating voltage range may include a range of approximately 550 volts to 850 volts and may pull up to approximately 500 Amps. An inverter, as discussed further in conjunction with FIG. 2, may convert the DC electric power stored by a battery into alternating current (AC) power and/or pulse width modulated (PWM) power and provide the AC and/or PWM power to the motors in each of the motor assemblies 106 as commutation signals.

The aircraft 100 includes a set of control surfaces, such as a right outboard elevator 114A, right inboard elevator 114B, left inboard elevator 114C, and left out board elevator 114D, hereinafter referred to in the singular as elevator 114 or in the plural as elevators 114. The elevators 114 are configured to control the pitch of the aircraft 100. In some cases, the elevators 114 on both sides of the aircraft 100 may be partitioned into two or more components to provide more precise control over the pitch of the aircraft 100 and/or to provide redundancy in the event of any component failure. For example, in some embodiments, having two or more elevators 114 on each side enables independently controlling those elevators 114 to enable more fine-tuned control over the pitch of the aircraft 100. Additionally, in the event of failure of a first elevator 114 on one side, a second elevator 114 on the same side may enable control of the pitch of the aircraft 100 on that side to mitigate the effects of the failure.

Additional control surfaces of the aircraft 100 include a right rudder 116A and left rudder 116B, hereinafter referred to in the singular as rudder 116 or in the plural as rudders 116, to control yaw of the aircraft 100. Although, unlike the elevators 114, the rudders 116 of the aircraft 100 are not depicted as partitioned on two sides it should be understood that in some airframe embodiments, the rudders 116 of the aircraft 100 may be partitioned on one or both sides. Still further, the aircraft 100 may include a right outboard aileron 118A, a right inboard aileron 118B, a left inboard aileron 118C, and a left outboard aileron 118D, hereinafter referred to in the singular as aileron 118 or in the plural as ailerons 118, to generate lift or drag. Any of the control surfaces 114, 116, 118 may be of more or less numbers and may be controlled by a pilot, a remote operator, or both, either directly or indirectly (e.g., fly-by-wire). Each of the control surfaces 114, 116, 118 may be controlled using one or more actuators (not shown).

As further depicted in FIG. 1, the aircraft 100 includes a flight controller 120. The flight controller 120 may include one or more flight controller components (e.g., one or more flight control computers (FCCs)) configured to generate command signal(s) that control the operation of various components of the aircraft 100. For example, the flight controller unit 120 may be configured to generate command signal(s) that control the operation of one or more inverters that provides electrical power and/or commutation within the motor assemblies 106 of the aircraft 100, an actuator that controls the operation of at least one control surface 114, 116, 118 of the aircraft 100, and/or the like.

A pilot (not shown) or other operator of the aircraft 100 may be in the cockpit 104 of the aircraft 100 to control the operation (e.g., speed, direction, altitude, etc.) of the aircraft 100. The pilot may interact with a variety of control devices (not shown) within the cockpit 104 to control the actions of the aircraft 100. The control devices may be configured to detect a pilot action and transmit pilot input data representing a desired action of the aircraft 100 (e.g., an electrical signal encoding the detected desired action) to the flight controller 120. A pilot control device may include a throttle lever, an inceptor stick, a lift lever, a steering wheel, a brake pedal, a pedal control, a toggle, a joystick, a collective pitch control device, an alpha-numeric input device (e.g., a keyboard), a pointing device, an audio input device (e.g., a microphone, a voice response system, etc.), a cursor control device (e.g., a mouse), a touchpad, an optical scanner, a video capture device, a touchscreen, and/or the like.

The flight controller 120 may identify inputs from the pilot and/or remote operator via one or more control devices and use those inputs to control various components of the aircraft 100. The aircraft 100 may perform the actions desired by the pilot and/or remote operator by way of commands generated by the flight controller 120 to move control surfaces 114, 116, 118 and/or control the motor assemblies 106. In some cases, the flight controller 120 may also receive signals from sensor(s) 122. The sensors 122 may provide a variety of information to the controller 120, such as location (e.g., latitude, longitude, altitude, etc.), obstructions, temperature, humidity, other environmental factors, etc. The flight controller 120 may be configured to change the operation of the aircraft 100 responsive to signals from the sensors 122.

The flight controller 120 may include a microprocessor, a digital signal processor (DSP), a system on a chip (SoC), a field-programmable gate array (FPGA), a complex programmable logic device (CPLD), an application specific integrated circuit (ASIC), a multi-chip module, a printed circuit board, and/or the like. In some embodiments, the flight controller 120 is configured to receive one or more pilot input signals from one or more pilot control devices, perform one or more signal processing operations (e.g., one or more time-frequency analysis operations) on the pilot control signal(s) to generate one or more transformed signals, and determine the pilot command signal based on the transformed signal(s). In some examples, the flight controller 120 may use one or more trained machine learning models to perform the signal processing operation(s) on pilot control signal(s) and/or sensor signal(s) to generate commands for various components of aircraft 100.

As described above, in some cases, the flight controller 120 may determine one or more command signals for controlling the aircraft 100 and/or a trajectory generated for the aircraft 100 based on sensor data provided by the sensor(s) 122. The sensor(s) 122 may include vision sensor(s), depth sensor(s) (e.g., LiDAR sensor(s)), torque sensor(s), gyroscope(s), accelerometer(s), magnetometer(s), inertial measurement unit(s) (IMU(s)), pressure sensor(s), force sensor(s), proximity sensor(s), displacement sensor(s), vibration sensor(s), environmental sensor(s), and/or the like.

In some cases, the flight controller 120 may include an attitude controller and/or a mixer used to generate adjusted motor commands. For instance, the attitude controller of the aircraft 100 may translate a pilot's input to one or more torque commands needed at motor assembly A 106A, motor assembly B 106B, motor assembly C 106C, motor assembly D 106D, and motor assembly E 106E to achieve the desired aircraft 100 attitude change. In this case, an RPM limit may be included as a constraint when generating the torque command (or other motor commands) to be applied to the motor assembly A 106A, motor assembly B 106B, motor assembly C 106C, motor assembly D 106D, and motor assembly E 106E. For example, the system may determine an aggregate torque and/or or acceleration that the entire aircraft 100 should experience and then determine a motor torque command for each motor assembly A 106A, motor assembly B 106B, motor assembly C 106C, motor assembly D 106D, and motor assembly E 106E in order to not exceed the aggregate torque and/or acceleration. A mixer may utilize different types of data (e.g., power limits, motor limits, battery power, torque limits, RPM limits, etc.) as constraints when calculating the torque commands. The mixer may be implemented in a number of different ways and consider multiple types of data, such as prioritizing particular maneuvers (e.g., pitch and roll over yaw). In some cases, an operating envelope for each motor assembly A 106A, motor assembly B 106B, motor assembly C 106C, motor assembly D 106D, and motor assembly E 106E of the aircraft may be generated that indicates an airspeed-based RPM limit that allow for the aircraft 100 to perform transitions (e.g., transitioning from vertical to forward flight) without causing unsafe load to be experienced by the aircraft 100.

In some examples, the flight controller 120 may be configured to generate an adjusted motor command based on one or more factors. For example, the flight controller 120 may be configured to generate an initial vehicle torque command and/or acceleration command based on input from a pilot control (e.g., an inceptor stick). These inputs may include commands for the plurality of propulsors as a function of a desired change in an attitude of the aircraft. For instance, the inputs may include a roll angle, a pitch angle, a yaw rate, and the like. In some cases, the flight controller 120 may also receive IMU data from the sensors 122 to be used in generating one or more outputs (e.g., torque commands). In this case, the flight controller 120 receives the pilot's desired command and determines an initial motor command (e.g., what the aircraft 100 level torque or acceleration should be to achieve the appropriate change in attitude at the appropriate velocity and acceleration).

In some examples, once the initial vehicle torque command and/or acceleration command are generated, the flight controller 120 may consider one or more constraints to generate adjusted motor commands. For example, the flight controller 120 may receive an airspeed-based RPM limit to be used in calculating the adjusted motor command. In some cases, the flight controller 120 may determine an airspeed that the aircraft 100 is traveling (e.g., via the sensors 122) and determine an RPM limit based on an operating envelope for a motor of the aircraft that indicates airspeed-based RPM limits that allow for the aircraft to perform maneuvers (e.g., transitioning from vertical to forward flight) without causing unsafe load to be experienced by the aircraft.

In some cases, the flight controller 120 may calculate adjusted motor commands for the plurality of propulsors based at least in part on the RPM limit and transmit the adjusted motor commands to the corresponding propulsors of the plurality of propulsors. For example, the flight controller 120 may determine what the torque should be at each lift motor to achieve the vehicle level torque. It may consider constraints (e.g. airspeed-based RPM limit, battery power, motor torque limit, etc.) and solve an optimization problem to determine the torque to be applied at each motor.

In some cases, the total torque may be less than the desired vehicle torque (if, for example, a motor torque constraint would be violated). In some examples, the actual total commanded torque may be fed back to the attitude controller for the next iteration.

Although discussed in the context of the eVTOL aircraft 100, it should be understood that the apparatus, systems, and methods disclosed herein to determine adjusted motor commands based on airspeed-based RPM limits may be applied to any suitable application. For example, the mechanism discussed herein may be applied to a conventional takeoff and landing (CTOL) aircraft or other transportation vehicles.

FIG. 2 depicts a system 200 configured for use in an aircraft, such as the aircraft 100. In some cases, the system 200 may comprise and/or otherwise be referred to as an attitude control. System 200 includes flight controller 202 configured to provide initial vehicle torque signal 204 for at least a propulsor, such as lift rotors 108A, 108B, 108C, 108D. Flight controller 202 may be a computing device as previously disclosed. Flight controller 202 may be a processor configured to control the output of a plurality of propulsors in response to inputs. Inputs to this system may include pilot manipulations of physical control interfaces, remote signals generated from electronic devices, voice commands, physiological readings like eye movements, pedal manipulation, or a combination thereof, to name a few. Flight controller 202 may include a proportional-integral-derivative (PID) controller. A “PID controller”, for the purposes of this disclosure, is a control loop mechanism employing feedback that calculates an error value as the difference between a desired setpoint and a measured process variable and applies a correction based on proportional, integral, and derivative terms; integral and derivative terms may be generated, respectively, using analog integrators and differentiators constructed with operational amplifiers and/or digital integrators and differentiators, as a non-limiting example. PID controllers may automatically apply accurate and responsive correction to a control function in a loop, such that over time the correction remains responsive to the previous output and actively controls an output. Flight controller 202 may include damping, including critical damping to attain the desired setpoint, which may be an output to a propulsor in a timely and accurate way.

In some cases, the flight controller 202 may be implemented consistently with any flight controller as described herein. Flight controller 202 is configured to provide an initial vehicle torque signal 204 comprising a plurality of attitude commands 206. Initial vehicle torque signal 204 may include a desired change in aircraft trajectory as inputted by an onboard or offboard pilot, remotely located user, one or more computing devices such as an “autopilot” program or module, any combination thereof, or the like. Initial vehicle torque signal 204 may include without limitation one or more electrical signals, audiovisual signals, physical indications of desired vehicle-level torques and forces, or the like. “Trajectory”, for the purposes of this disclosure is the path followed by a projectile or vehicle flying or an object moving under the action of given forces. Trajectory may be altered by aircraft control surfaces and/or one or more propulsors working in tandem to manipulate a fluid medium in which the object is moving through. Initial vehicle torque signal 204 may include a signal generated from manipulation of a pilot input control consistent with the entirety of this disclosure.

In some examples, vehicle torque signal 204 may comprise a plurality of attitude commands 206. Initial vehicle torque signal 204 may include a desired change in aircraft trajectory as inputted by an onboard or offboard pilot, remotely located user, one or more computing devices such as an “autopilot” program or module, any combination thereof, or the like. Initial vehicle torque signal 204 may include without limitation one or more electrical signals, audiovisual signals, physical indications of desired vehicle-level torques and forces, or the like. “Trajectory”, for the purposes of this disclosure is the path followed by a projectile or vehicle flying or an object moving under the action of given forces. Trajectory may be altered by aircraft control surfaces and/or one or more propulsors working in tandem to manipulate a fluid medium in which the object is moving through. Initial vehicle torque signal 204 may include a signal generated from manipulation of a pilot input control consistent with the entirety of this disclosure.

In some examples, flight controller 202 may include one or more circuit elements communicatively coupled together. One or more sensors may be communicatively coupled to at least a pilot control, the manipulation of which, may constitute at least an aircraft command. Signals may include electrical, electromagnetic, visual, audio, radio waves, or another undisclosed signal type alone or in combination. At least a sensor communicatively connected to at least a pilot control may include a sensor disposed on, near, around or within at least pilot control. At least a sensor may include a motion sensor. “Motion sensor”, for the purposes of this disclosure refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. At least a sensor may include, torque sensor, gyroscope, accelerometer, torque sensor, magnetometer, inertial measurement unit (IMU), pressure sensor, force sensor, proximity sensor, displacement sensor, vibration sensor, among others. At least a sensor may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings.

In some cases, at least a sensor may be configured to detect pilot input from at least pilot control. At least pilot control may include a throttle lever, inceptor stick, collective pitch control, steering wheel, brake pedals, pedal controls, toggles, joystick. One of ordinary skill in the art, upon reading the entirety of this disclosure would appreciate the variety of pilot input controls that may be present in an electric aircraft consistent with the present disclosure. At least pilot control may be physically located in the cockpit of the aircraft or remotely located outside of the aircraft in another location communicatively connected to at least a portion of the aircraft. “Communicatively connect”, for the purposes of this disclosure, is a process whereby one device, component, or circuit is able to receive data from and/or transmit data to another device, component, or circuit; communicative connecting may be performed by wired or wireless electronic communication, either directly or by way of one or more intervening devices or components. In an embodiment, communicative connecting includes electrically coupling an output of one device, component, or circuit to an input of another device, component, or circuit. Communicative connecting may be performed via a bus or other facility for intercommunication between elements of a computing device. Communicative connecting may include indirect connections via “wireless” connection, low power wide area network, radio communication, optical communication, magnetic, capacitive, or optical coupling, or the like. At least pilot control may include buttons, switches, or other binary inputs in addition to, or alternatively than digital controls about which a plurality of inputs may be received. At least pilot control may be configured to receive pilot input. Pilot input may include a physical manipulation of a control like a pilot using a hand and arm to push or pull a lever, or a pilot using a finger to manipulate a switch. Pilot input may include a voice command by a pilot to a microphone and computing system consistent with the entirety of this disclosure. One of ordinary skill in the art, after reviewing the entirety of this disclosure, would appreciate that this is a non-exhaustive list of components and interactions thereof that may include, represent, or constitute, initial vehicle torque signal 204.

In some examples, initial vehicle torque signal 204, which is provided by flight controller 202, includes a plurality of attitude commands 206. “Attitude”, for the purposes of this disclosure, is the relative orientation of a body, in this case an electric aircraft, as compared to earth's surface or any other reference point and/or coordinate system. Attitude is generally displayed to pilots, personnel, remote users, or one or more computing devices in an attitude indicator, such as without limitation a visual representation of the horizon and its relative orientation to the aircraft. Plurality of attitude commands 206 may indicate one or more measurements relative to an aircraft's pitch, roll, yaw, or throttle compared to a relative starting point. One or more sensors may measure or detect the aircraft's attitude and establish one or more attitude datums. An “attitude datum”, for the purposes of this disclosure, refers to at least an element of data identifying and/or a pilot input or command. At least a pilot control may be communicatively connected to any other component presented in system, the communicative connection may include redundant connections configured to safeguard against single-point failure. Plurality of attitude commands 206 may indicate a pilot's instruction to change the heading and/or trim of an electric aircraft. Pilot input may indicate a pilot's instruction to change an aircraft's pitch, roll, yaw, throttle, and/or any combination thereof. Aircraft trajectory may be manipulated by one or more control surfaces and propulsors working alone or in tandem consistent with the entirety of this disclosure, hereinbelow. “Pitch”, for the purposes of this disclosure refers to an aircraft's angle of attack, that is the difference between the aircraft's nose and a horizontal flight trajectory. For example, an aircraft may pitch “up” when its nose is angled upward compared to horizontal flight, as in a climb maneuver. In another example, an aircraft may pitch “down”, when its nose is angled downward compared to horizontal flight, like in a dive maneuver. “Roll” for the purposes of this disclosure, refers to an aircraft's position about its longitudinal axis, that is to say that when an aircraft rotates about its axis from its tail to its nose, and one side rolls upward, as in a banking maneuver. “Yaw”, for the purposes of this disclosure, refers to an aircraft's heading angle, when an aircraft rotates about an imaginary vertical axis intersecting the center of the earth and the fuselage of the aircraft. “Throttle”, for the purposes of this disclosure, refers to an aircraft outputting an amount of thrust from a propulsor. Pilot input, when referring to throttle, may refer to a pilot's desire to increase or decrease thrust produced by at least a propulsor. Initial vehicle torque signal 204 may include an electrical signal. At least an aircraft command may include mechanical movement of any throttle consistent with the entirety of this disclosure. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sine function, or pulse width modulated signal. At least a sensor may include circuitry, computing devices, electronic components or a combination thereof that translates pilot input into at initial vehicle torque signal 204 configured to be transmitted to another electronic component. Plurality of attitude commands 206 may include a total attitude command datum, such as a combination of attitude adjustments represented by one or a certain number of combinatorial datums. Plurality of attitude commands 206 may include individual attitude datums representing total or relative change in attitude measurements relative to pitch, roll, yaw, and throttle.

In some examples, vehicle-level torque commands such as initial vehicle torque signal 204 may be translated into propulsor commands such as output torque command 224 through modified attitude commands 216 in mixer 214 such that onboard electronics solve systems of equations in pitch moment, roll moment, yaw moment, and collective force may send each of a plurality of propulsors signals to achieve the desired vehicle torque. It should be noted that “collective force” may additionally or alternatively be called “assisted lift force” and that this terminology does not alter the meaning of either “collective force” or “assisted lift force” as used herein. Here, “desired vehicle torque” is directly related to initial vehicle torque signal 204 consistent with the disclosure. It should be noted by one of ordinary skill in the art that initial vehicle torque signal 204 may be received from flight controller 202 as a calculated input, user input, or combination thereof. Flight controller 202 may include and/or communicate with any computing device, including without limitation a microcontroller, microprocessor, digital signal processor (DSP) and/or system on a chip (SoC).

Flight controller 202 may be programmed to operate electronic aircraft to perform at least a flight maneuver; at least a flight maneuver may include takeoff, landing, stability control maneuvers, emergency response maneuvers, regulation of altitude, roll, pitch, yaw, speed, acceleration, or the like during any phase of flight. At least a flight maneuver may include a flight plan or sequence of maneuvers to be performed during a flight plan. Flight controller 202 may be designed and configured to operate electronic aircraft via fly-by-wire. Flight controller 202 is communicatively connected to each propulsor; as used herein, flight controller 202 is communicatively connected to each propulsor where flight controller 202 is able to transmit signals to each propulsor and each propulsor is configured to modify an aspect of propulsor behavior in response to the signals. As a non-limiting example, flight controller 202 may transmit signals to a propulsor via an electrical circuit connecting flight controller 202 to the propulsor; the circuit may include a direct conductive path from flight controller 202 to propulsor or may include an isolated coupling such as an optical or inductive coupling. Alternatively, or additionally, flight controller 202 may communicate with a propulsor using wireless communication, such as without limitation communication performed using electromagnetic radiation including optical and/or radio communication, or communication via magnetic or capacitive coupling. Vehicle controller may be fully incorporated in an electric aircraft containing a propulsor and may be a remote device operating the electric aircraft remotely via wireless or radio signals, or may be a combination thereof, such as a computing device in the aircraft configured to perform some steps or actions described herein while a remote device is configured to perform other steps. Persons skilled in the art will be aware, after reviewing the entirety of this disclosure, of many different forms and protocols of communication that may be used to communicatively connect flight controller 202 to propulsors.

In some examples, system 200 includes mixer 214 configured to receive initial vehicle torque signal 204 including plurality of attitude commands 206. Receiving may include receiving one or more electrical signals transmitted wirelessly or through a wired connection. Mixer 214 may be one or more computing devices configured to perform torque allocation to one or more propulsors in an electric aircraft to alter pitch, roll, yaw, and lift (or throttle). Initial vehicle torque signal 204 may be any initial vehicle torque signal as described herein. Initial vehicle torque signal 204 may represent one or more elements of data describing current, past, or future aircraft orientations relative to the earth's horizon, or attitude, thus including a plurality of attitude commands 206 as described herein.

In some examples, a “mixer”, for the purposes of this disclosure, may be a component that takes in at least an incoming signal, such as initial vehicle torque signal 204 including plurality of attitude commands 206 and allocates one or more outgoing signals, such as modified attitude commands 216 and output torque command 224, or the like, to at least a propulsor, flight component, or one or more computing devices connected thereto. One of ordinary skill in the art, after reading the entirety of this disclosure, would be aware that a mixer, as used herein, may additionally or alternatively be described as performing “control allocation” or “torque allocation”. For example, mixer 214 may take in commands to alter aircraft trajectory that requires a change in pitch and yaw. Mixer 214 may allocate torque to at least one propulsor (or more) that do not independently alter pitch and yaw in combination to accomplish the command to change pitch and yaw. More than one propulsor may be required to adjust torques to accomplish the command to change pitch and yaw, mixer 214 would take in the command and allocate those torques to the appropriate propulsors consistent with the entirety of this disclosure. One of ordinary skill in the art, after reading the entirety of this disclosure, will appreciate the limitless combination of propulsors, flight components, control surfaces, or combinations thereof that could be used in tandem to generate some amount of authority in pitch, roll, yaw, and lift of an electric aircraft consistent with this disclosure. Mixer 214 may be consistent with any mixer described herein. Mixer 214 may be implemented using an electrical logic circuit. “Logic circuits”, for the purposes of this disclosure, refer to an arrangement of electronic components such as diodes or transistors acting as electronic switches configured to act on one or more binary inputs that produce a single binary output. Logic circuits may include devices such as multiplexers, registers, arithmetic logic units (ALUs), computer memory, and microprocessors, among others. In modern practice, metal-oxide-semiconductor field-effect transistors (MOSFETs) may be implemented as logic circuit components. Mixer 214 may be implemented using a processor. Mixer 214 is configured to receive the initial vehicle torque signal 204 for at least a propulsor from flight controller 202. Mixer 214 solves at least an optimization problem. At least an optimization problem may include solving the pitch moment function that may be a nonlinear program.

In some examples, system 200 includes mixer 214 configured to receive at least a vehicle torque limit 208. Vehicle torque limit 208 may include one or more elements of data representing maxima, minima, or other limits on vehicle torques, forces, attitudes, rates of change, or a combination thereof. Vehicle torque limit 208 may include individual limits on one or more propulsors, one or more flight components, structural stress or strain, energy consumption limits, or a combination thereof. Vehicle torque limit 208 may include attitudes in which aircraft cannot enter such as maximum or minimum pitch angle or pitch angle rate of change, vehicle torque limit 208 in a non-limiting example, may include a limit on one or more propulsors calculated in order to keep aircraft within a pitch angle range. Vehicle torque limit 208 may be a relative limit, as in a non-limiting example, may include maximum lift from one or more propulsors based on environmental factors such as air density. Vehicle torque limits 208 may include graphical limits, such as points or lines on a graphical representation of certain attitudes, such as pitch vs. lift, or pitch vs. roll, for example. Vehicle torque limits 208 may be displayed to a pilot, user, or be embedded in the controls such that a pilot is unable to maneuver an aircraft that would violate a vehicle torque limit 208 as described herein.

In some examples, mixer 214 includes circuitry configured to receive a plurality of prioritization data 210 including a prioritization datum 212 corresponding to each of the plurality of attitude commands 206. Plurality of prioritization data 210 may include one or more elements of data representing relative weight, importance, preservation, or otherwise ranking of attitudes of an aircraft. Prioritization datum 212 may be one of the plurality of prioritization data 210, such as the relative importance of each attitude command. For example, and without limitation, prioritization datum 212 may include a coefficient associated with the pitch attitude command, this coefficient would determine a rank of preservation of pitch attitude command relative to roll, yaw, and lift. That is to say that if a pilot commands aircraft to change pitch and yaw, and the command would violate vehicle torque limit 208, the mixer 214 would determine the relatively higher importance of pitch, and preserve the pitch command, while compromising the yaw command, according to available power to the propulsor.

In some examples, mixer 214 includes circuitry configured to receive an RPM limit 220 based on an operating envelope 218 to be used when generating the modified attitude commands 216. For example, the flight controller 202 may determine an airspeed that the aircraft 100 is traveling (e.g., via the sensors 122) and determine an RPM limit based on the operating envelope 218 for a motor of the aircraft that indicates airspeed-based RPM limits that allow for the aircraft to perform maneuvers (e.g., transitioning from vertical to forward flight) without causing unsafe load to be experienced by the aircraft.

In some examples, mixer 214 is configured to determine a plurality of modified attitude commands 216 as a function of the at least a vehicle torque limit 208, plurality of attitude commands 206, the plurality of prioritization data 210, and/or the RPM limit 220. Mixer 214 may allocate torque to plurality of propulsors such that attitude commands 206 are adjusted as a function of the prioritization data 210, vehicle torque limits 208, and/or the RPM limit 220. Modified attitude commands 216 may be prioritized to preserve more important attitude commands, for instance as represented by prioritization data 210, when the vehicle torque limits 208 and/or the RPM limit 220 precludes all attitude commands 206 from being executed exactly as inputted. Modified attitude commands 216 may include one or more attitude commands within the vehicle torque limits 208 and/or the RPM limit 220. Mixer 214 may generate modified attitude command 216 for at least a propulsor as a function of solving the at least an optimization problem. Mixer 214 may transmit modified attitude command 216 to at least a propulsor. Modified attitude command 216 may be used iteratively as a torque limit in a control loop such that system 200 can adjust at a certain rate to outside conditions such as environmental conditions, namely airspeed, altitude, attitude, air density, and the like. In some examples, an RPM limit, such as the RPM limit 220, may be dynamically converted into a torque limit, such as the vehicle torque limits 208. For example, the mixer 214 may calculate an adjusted motor commands based on the prioritization data 210 and the RPM limit 220 by determining that a required RPM associated with a command exceeds the RPM limit 220. In this case, the mixer 214 may calculate the adjusted motor commands based on the prioritization data 210. In some cases, this may include the torque limits 208 changing as a function of RPM upon each execution of the system.

In some examples, mixer 214 is configured to generate, as a function of modified attitude commands 216, output torque command 224. Output torque command 224 may include one or more signals to one or more propulsors indicating the torque to be produced at the one or more propulsors to achieve the modified attitude commands 216. For example, and without limitation, where modified attitude command 216 includes a pitch up of 5 degrees and a change in yaw to the right of 2 degrees, output torque command 224 may indicate the output each propulsor must output individually to maneuver the aircraft in tandem. Output torque command 224 may include electrical signals consistent with the entirety of this disclosure, which may be generated based on the torque command in any manner that may occur to a person skilled in the art upon reviewing the entirety of this disclosure.

In some examples, mixer 214 may be configured to generate, as a function of output torque command 224, remaining vehicle torque 226. Remaining vehicle torque 226 may include torque available at each of a plurality of propulsors at any point during an aircraft's entire flight envelope, such as before, during, or after a maneuver. For example, and without limitation, output torque command 224 may indicates torque a propulsor must output to accomplish a maneuver; remaining vehicle torque may then be calculated based on one or more of the propulsor limits, vehicle torque limits as described herein, environmental limits as described herein, or a combination thereof. Remaining vehicle torque 226 may be represented, as a non-limiting example, as a total torque available at an aircraft level, such as the remaining torque available in any plane of motion or attitude component such as pitch torque, roll torque, yaw torque, and/or lift torque.

In some examples, mixer 214 may be configured to solve at least an optimization problem, which may be an objective function. An “objective function,” as used in this disclosure, is a mathematical function with a solution set including a plurality of data elements to be compared. Mixer 214 may compute a score, metric, ranking, or the like, associated with each performance prognoses and candidate transfer apparatus and select objectives to minimize and/or maximize the score/rank, depending on whether an optimal result is represented, respectively, by a minimal and/or maximal score; an objective function may be used by mixer 214 to score each possible pairing. At least an optimization problem may be based on one or more objectives, as described below. Mixer 214 may pair a candidate transfer apparatus, with a given combination of performance prognoses, that optimizes the objective function. In various embodiments solving at least an optimization problem may be based on a combination of one or more factors. Each factor may be assigned a score based on predetermined variables. In some embodiments, the assigned scores may be weighted or unweighted.

Solving at least an optimization problem may include performing a greedy algorithm process, where optimization is performed by minimizing and/or maximizing an output of objective function. A “greedy algorithm” is defined as an algorithm that selects locally optimal choices, which may or may not generate a globally optimal solution. For instance, mixer 214 may select objectives so that scores associated therewith are the best score for each goal. For instance, in non-limiting illustrative example, optimization may determine the pitch moment associated with an output of at least a propulsor based on an input.

In some examples, at least an optimization problem may be formulated as a linear objective function, which mixer 214 may optimize using a linear program such as without limitation a mixed-integer program. A “linear program,” as used in this disclosure, is a program that optimizes a linear objective function, given at least a constraint; a linear program maybe referred to without limitation as a “linear optimization” process and/or algorithm. For instance, in non-limiting illustrative examples, a given constraint might be torque limit, and a linear program may use a linear objective function to calculate maximum output based on the limit. In various embodiments, mixer 214 may determine a set of instructions towards achieving a user's goal that maximizes a total score subject to a constraint that there are other competing objectives. A mathematical solver may be implemented to solve for the set of instructions that maximizes scores; mathematical solver may be implemented on mixer 214 and/or another device in system 200, and/or may be implemented on third-party solver. At least an optimization problem may be formulated as nonlinear least squares optimization process. A “nonlinear least squares optimization process,” for the purposes of this disclosure, is a form of least squares analysis used to fit a set of m observations with a model that is non-linear in n unknown parameters, where m is greater than or equal to n. The basis of the method is to approximate the model by a linear one and to refine the parameters by successive iterations. A nonlinear least squares optimization process may output a fit of signals to at least a propulsor. Solving at least an optimization problem may include minimizing a loss function, where a “loss function” is an expression an output of which a ranking process minimizes to generate an optimal result. As a non-limiting example, mixer 214 may assign variables relating to a set of parameters, which may correspond to score components as described above, calculate an output of mathematical expression using the variables, and select an objective that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs.

In some examples, mixer 214 may include an inertia compensator. An inertia compensator may include one or more computing devices, an electrical component, circuitry, one or more logic circuits or processors, or the like, which may be configured to compensate for inertia in one or more propulsors present in system 200. Mixer 214 is configured, in general, to output signals and command propulsors to produce a certain amount of torque; however, real-world propulsors contain mass, and therefore have inertia. “Inertia”, for the purposes of this disclosure, is a property of matter by which it continues in its existing state of rest or uniform motion in a straight line, unless that state is changed by an external force.

Specifically, in this case, a massive object requires more force or torque to start motion than is required to continue producing torque. In a control system, mixer 214 must therefore modulate the would-be signal to account for inertia of the physical system being commanded. The inertia compensator may make appropriate calculations based on modified attitude command 216, output torque command 224, RPM limit 220 and other considerations like environmental conditions, available power, vehicle torque limits 208, among others. Inertia compensator may adjust vehicle torque limits 208 for certain periods of time wherein, for example, output torque command 224 may be allowed to overspeed a propulsor to start the propulsor′ s rotating physical components and then quickly step down the torque as required to maintain the commanded torque. The inertia compensator may include a lead filter.

In some cases, mixer 214 may be configured to determine an expected propulsor inertia associated with a command, determine an additional torque required to overcome the expected propulsor inertia, and calculate an adjusted motor commands based on the additional torque. In some cases, propulsor inertia may include any type of propulsor dynamics. For instance, in the context of the control surfaces discussed herein, compensation may be applied in the same or similar way. For instance, a position response may be increased (as opposed to increasing a velocity response) in cases utilizing a variable speed propeller (e.g., such as lift propellors).

Mixer 214 may be configured to generate a first torque command for at least a propulsor. First torque command may include at least a torque vector. First torque command may be represented in any suitable form, which may include, without limitation, vectors, matrices, coefficients, scores, ranks, or other numerical comparators, and the like. A “vector” as defined in this disclosure is a data structure that represents one or more quantitative values and/or measures of forces, torques, signals, commands, or any other data structure as described in the entirety of this disclosure. A vector may be represented as an n-tuple of values, where n is at least two values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented n-tuple of values, such that a vector has a geometric direction characterizing the relative quantities of attributes in the n-tuple as compared to each other. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿαᵢ²}, where αᵢ is attribute number i of the vector. Scaling and/or normalization may function to make vector comparison independent of absolute quantities of attributes, while preserving any dependency on similarity of attributes. One of ordinary skill in the art would appreciate a vector to be a mathematical value consisting of a direction and magnitude.

In some examples, “torque”, for the purposes of this disclosure, refers to a twisting force that tends to cause rotation. Torque is the rotational equivalent of linear force. In three dimensions, the torque is a pseudovector; for point particles, it is given by the cross product of the position vector (distance vector) and the force vector. The magnitude of torque of a rigid body depends on three quantities: the force applied, the lever arm vector connecting the point about which the torque is being measured to the point of force application, and the angle between the force and lever arm vectors. A force applied perpendicularly to a lever multiplied by its distance from the lever's fulcrum (the length of the lever arm) is its torque. A force of three newtons applied two meters from the fulcrum, for example, exerts the same torque as a force of one newton applied six meters from the fulcrum. The direction of the torque can be determined by using the right-hand grip rule: if the fingers of the right hand are curled from the direction of the lever arm to the direction of the force, then the thumb points in the direction of the torque. One of ordinary skill in the art would appreciate that torque is represented as a vector, consistent with this disclosure, and therefore includes a magnitude of force and a direction. “Torque” and “moment” are equivalents for the purposes of this disclosure. Any torque command or signal herein may include at least the steady state torque to achieve the initial vehicle torque signal 204 output to at least a propulsor.

In some examples, system 200 includes display 222. Display 222 is configured to present, to a user, the remaining vehicle torque 226 and the output toque command 224. Display 222 may include a graphical user interface, multi-function display (MFD), primary display, gauges, graphs, audio cues, visual cues, information on a heads-up display (HUD) or a combination thereof. Display 222 may include a display disposed in one or more areas of an aircraft, on a user device remotely located, one or more computing devices, or a combination thereof. Display 222 may be disposed in a projection, hologram, or screen within a user's helmet, eyeglasses, contact lens, or a combination thereof. System 200 may include display 222 that displays remaining vehicle torque 226 to a user in graphical form. Graphical form may include a two-dimensional plot of two variables in that represent real-world data, such as pitch torque vs. roll torque of an aircraft. System 200 may include display 222 wherein the remaining vehicle torque 226 is presented to a user in a graphical representation of an electric aircraft. In a nonlimiting example, a graphical representation of an electric aircraft may show arrows, levels, bar graphs, percentages, or another representation of remaining vehicle torques in a plurality of planes of motion such as pitch moment, roll moment, yaw moment, and lift force, individually or collectively. Remaining vehicle torque 226 may include remaining vehicle torque capability in an aircraft's pitch moment. Remaining vehicle torque 226 may include the remaining vehicle torque capability in an aircraft's roll moment.

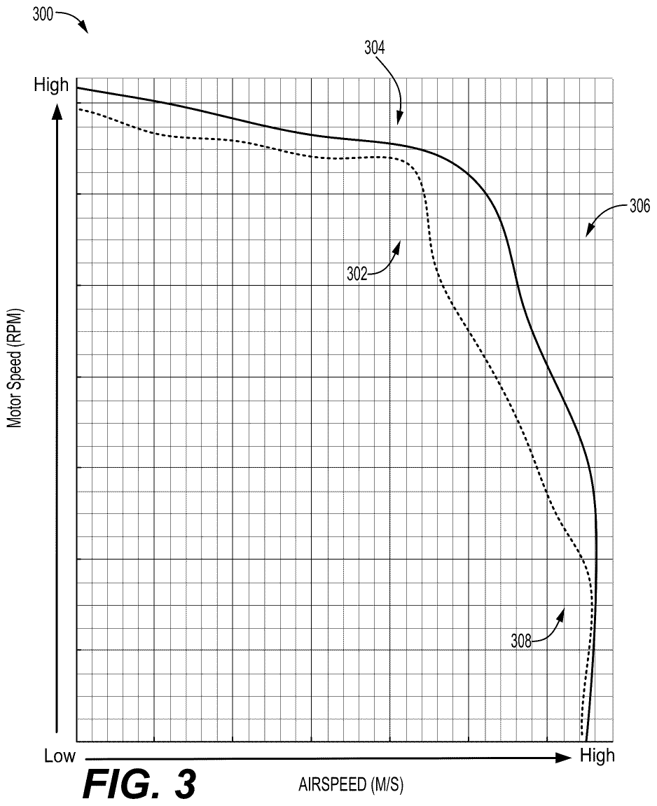

FIG. 3 illustrates an example chart 300 depicting an airspeed-based RPM limit graph. The chart 300 includes a motor speed on the y-axis and an airspeed on the x-axis. The chart 300 is representative of an aircraft experiencing increased load as airspeed increases, with the top right corner of the chart 300 representing a maximum load and the bottom left corner of the chart 300 representing a minimum load. In general, it is desirable for an aircraft to experience less load while in flight so that the aircraft does not require additional material and structural support to handle the load, which increases weight of the aircraft and decreases efficiency. The chart 300 illustrates a first curve 302 representing a first transition maneuver of an aircraft and a second curve 304 representing a second transition maneuver of an aircraft. The first transition maneuver of the first curve 302 represents a normal operating condition of the aircraft in which the aircraft experiences a lesser load stress (e.g., relative to the second transition maneuver) because the aircraft is performing the transition less aggressively. The second transition maneuver of the second curve 304 represents an aggressive transition maneuver made by the aircraft in which the aircraft experiences a greater load stress (e.g., relative to the first transition maneuver). An example of performing an aggressive transition maneuver may include performing a transition maneuver (e.g., transitioning from vertical flight to forward flight) while the aircraft is 5,000 feet above ground level (AGL), 38 deg SL temperature, and/or 7100 ft DA. The data obtained from chart 300 may be used to generate an operating envelope in which the portion 306 located above and to the right side of the second curve 304 is removed. In some cases, the chart 300 may indicate that at point “A” 308 (e.g., approximately 65 Knots Equivalent Air Speed (KEAS)), the aircraft begins to experience an increased load capacity that may cause unsafe flying conditions.

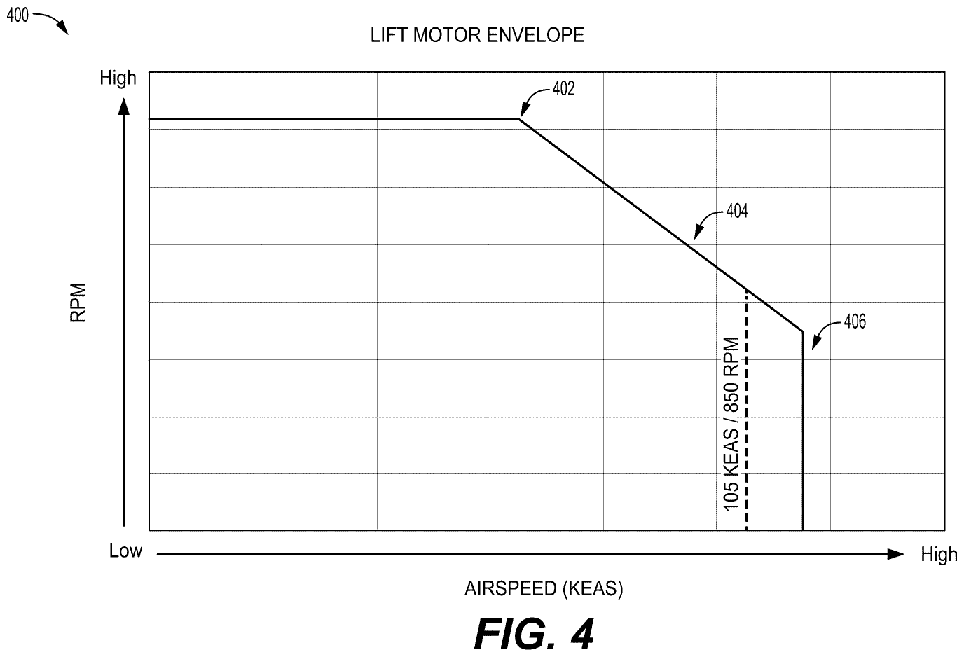

FIG. 4 illustrates an example operating envelope 400 usable by an aircraft, such as aircraft 100, to determine an airspeed-based RPM limit when generating motor commands. In some cases, the operating envelope 400 is based on the chart 300 and is configured to reduce and/or limit a load experienced by an aircraft when the aircraft is performing a transition maneuver. For example, as determined by the chart 300, at approximately point A 308 (e.g., 65 Knots Equivalent Air Speed (KEAS)), the aircraft begins to experience an increased load capacity that may cause unsafe flying conditions. The operating envelope 400 may reduce the RPM limit provided to the mixer for calculating motor commands when this airspeed is reached. For example, prior to point A 402, the RPM limit may be set at a higher RPM (e.g., 1440 RPM). Once point A 308 is reached by the aircraft, the RPM limit may be reduced, as illustrated by the transition line 404. In this way, the mixer in an attitude controller may utilize an airspeed-based RPM limit, as well as other data, when generating and outputting motor commands. Particularly in aircraft utilizing fixed pitch lift propellers that do not have cyclic or collective blade pitch control, increased differential loads may be experienced on blades of the propeller. Excessive load on the blades of the propeller as well as other portions of the aircraft may cause damage to the aircraft resulting in unsafe flying conditions. The operating envelope 400 may indicate airspeed-based RPM limits that allow for the aircraft to perform reasonably aggressive transitions (e.g., transitioning from vertical to forward flight) without causing unsafe load to be experienced by the aircraft. In some cases, the operating envelope 400 includes an upper boundary limit 406 that is based on an operational mission including an accelerating transition utilized when transitioning from a hover maneuver to a fixed wing flight maneuver. In some cases, the upper boundary limit 406 is based on preventing an inadvertent stall by the aircraft. In some cases, the upper boundary limit 406 is based on a weight of the aircraft and/or an ambient temperature.

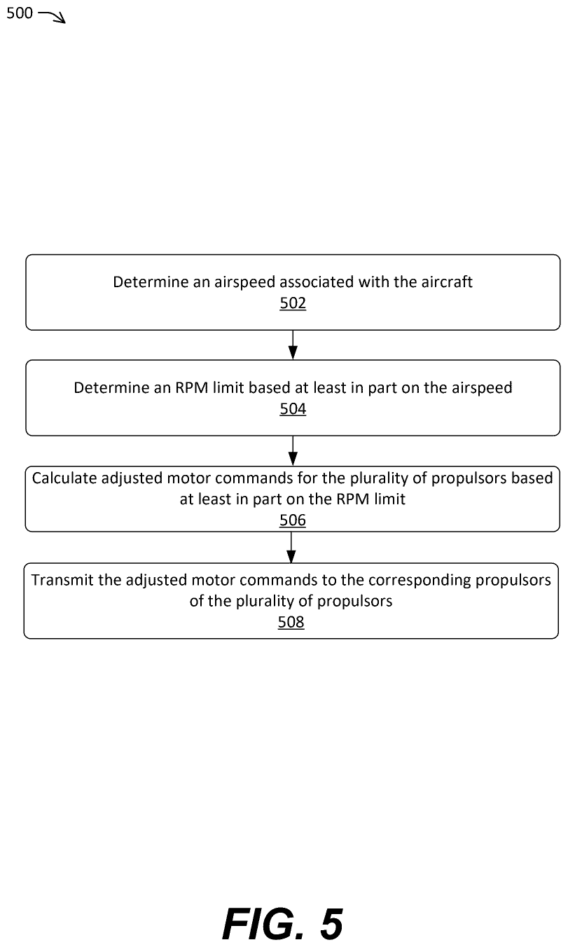

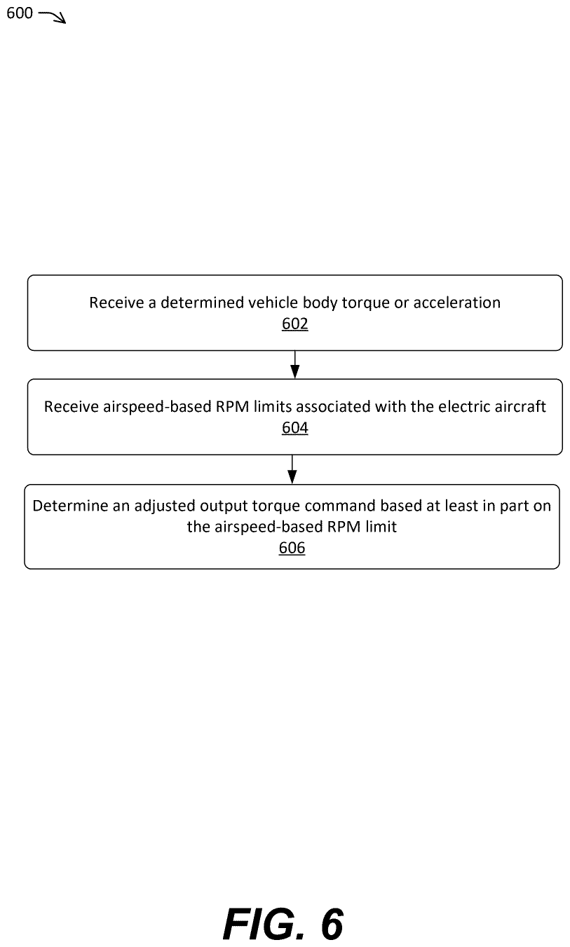

FIGS. 5 and 6 illustrate example processes and sequence diagrams in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order, omitted, and/or performed in parallel to implement the processes.

FIG. 5 is a flow diagram depicting an example method 500 for utilizing an airspeed-based RPM limit for generating motor commands usable by aircraft 100 of FIG. 1, according to examples of the disclosure. The processes of method 500 may be performed by the system 200, individually or in conjunction with one or more other elements of the aircraft 100. According to examples of the disclosure, method 500 may be performed while the aircraft 100 is in flight.

At block 502, the method 500 may include determining an airspeed associated with the aircraft and at block 504, the method 500 may include determining an RPM limit based at least in part on the airspeed. For instance, mixer 214 includes circuitry configured to receive an RPM limit 220 based on an operating envelope 218 to be used when generating the modified attitude commands 216. For example, the flight controller 202 may determine an airspeed that the aircraft 100 is traveling (e.g., via the sensors 122) and determine an RPM limit based on the operating envelope 218 for a motor of the aircraft that indicates airspeed-based RPM limits that allow for the aircraft to perform maneuvers (e.g., transitioning from vertical to forward flight) without causing unsafe load to be experienced by the aircraft. In some cases, an RPM limit may be determined for each individual propulsor, such as lift rotors 108A, 108B, 108C, 108D. For example, the mixer 214 may be configured to generate operating envelopes for each propulsor and determine different RPM limits for each propulsor based on the respective operating envelope. In some cases, the RPM limit and/or the operating envelope may be determined based on other types of data in addition to airspeed data. For instance, the RPM limit and/or the operating envelope may be determined based on service history data associated with the propulsors, heath data associated with the propulsors, etc. The RPM limits discussed herein may refer to limits on the RPM of individual propulsors (e.g., rotors) used by an aircraft to operate.

At block 506, the method 500 may include calculating adjusted motor commands for the plurality of propulsors based at least in part on the RPM limit. For example, mixer 214 is configured to determine a plurality of modified attitude commands 216 as a function of the at least a vehicle torque limit 208, plurality of attitude commands 206, the plurality of prioritization data 210, and/or the RPM limit 220. Mixer 214 may allocate torque to plurality of propulsors such that attitude commands 206 are adjusted as a function of the prioritization data 210, vehicle torque limits 208, and/or the RPM limit 220. Modified attitude commands 216 may be prioritized to preserve more important attitude commands, for instance as represented by prioritization data 210, when the vehicle torque limits 208 and/or the RPM limit 220 precludes all attitude commands 206 from being executed exactly as inputted. Modified attitude commands 216 may include one or more attitude commands within the vehicle torque limits 208 and/or the RPM limit 220.

At block 508, the method 500 may include transmitting the adjusted motor commands to the corresponding propulsors of the plurality of propulsors. For example, mixer 214 is configured to generate, as a function of modified attitude commands 216, output torque command 224. Output torque command 224 may include one or more signals to one or more propulsors indicating the torque to be produced at the one or more propulsors to achieve the modified attitude commands 216. For example, and without limitation, where modified attitude command 216 includes a pitch up of 5 degrees and a change in yaw to the right of 2 degrees, output torque command 224 may indicate the output each propulsor must output individually to maneuver the aircraft in tandem. Output torque command 224 may include electrical signals consistent with the entirety of this disclosure, which may be generated based on the torque command in any manner that may occur to a person skilled in the art upon reviewing the entirety of this disclosure.

FIG. 6 is a flow diagram depicting an example method 600 for utilizing an airspeed-based RPM limit for generating motor commands usable by aircraft 100 of FIG. 1, according to examples of the disclosure. The processes of method 600 may be performed by the system 200, individually or in conjunction with one or more other elements of the aircraft 100. According to examples of the disclosure, method 600 may be performed while the aircraft 100 is in flight.

At block 602, the method 600 may include receiving a determined vehicle body torque or acceleration. For example, flight controller 202 is configured to provide an initial vehicle torque signal 204 comprising a plurality of attitude commands 206. Initial vehicle torque signal 204 may include a desired change in aircraft trajectory as inputted by an onboard or offboard pilot, remotely located user, one or more computing devices such as an “autopilot” program or module, any combination thereof, or the like. Initial vehicle torque signal 204 may include without limitation one or more electrical signals, audiovisual signals, physical indications of desired vehicle-level torques and forces, or the like. “Trajectory”, for the purposes of this disclosure is the path followed by a projectile or vehicle flying or an object moving under the action of given forces. Trajectory may be altered by aircraft control surfaces and/or one or more propulsors working in tandem to manipulate a fluid medium in which the object is moving through. Initial vehicle torque signal 204 may include a signal generated from manipulation of a pilot input control consistent with the entirety of this disclosure.

At block 604, the method 600 may receiving airspeed-based RPM limits associated with the electric aircraft. For example, mixer 214 includes circuitry configured to receive an RPM limit 220 based on an operating envelope 218 to be used when generating the modified attitude commands 216. For example, the flight controller 202 may determine an airspeed that the aircraft 100 is traveling (e.g., via the sensors 122) and determine an RPM limit based on the operating envelope 218 for a motor of the aircraft that indicates airspeed-based RPM limits that allow for the aircraft to perform maneuvers (e.g., transitioning from vertical to forward flight) without causing unsafe load to be experienced by the aircraft.

At block 606, the method 600 may include determining an adjusted output torque command based at least in part on the airspeed-based RPM limit. For example, mixer 214 is configured to determine a plurality of modified attitude commands 216 as a function of the at least a vehicle torque limit 208, plurality of attitude commands 206, the plurality of prioritization data 210, and/or the RPM limit 220. Mixer 214 may allocate torque to plurality of propulsors such that attitude commands 206 are adjusted as a function of the prioritization data 210, vehicle torque limits 208, and/or the RPM limit 220. Modified attitude commands 216 may be prioritized to preserve more important attitude commands, for instance as represented by prioritization data 210, when the vehicle torque limits 208 and/or the RPM limit 220 precludes all attitude commands 206 from being executed exactly as inputted. Modified attitude commands 216 may include one or more attitude commands within the vehicle torque limits 208 and/or the RPM limit 220.

It should be noted that some of the operations of method 600 may be performed out of the order presented, with additional elements, and/or without some elements. Some of the operations of method 600 may further take place substantially concurrently and, therefore, may conclude in an order different from the order of operations shown above.

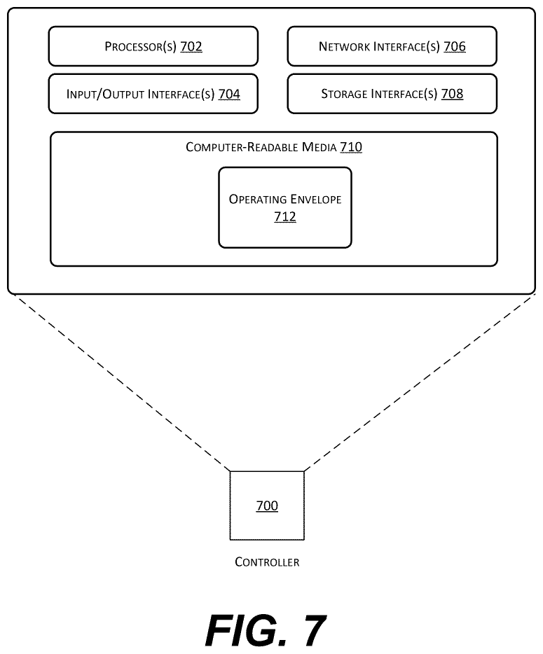

FIG. 7 is a block diagram of a controller 700 of that may include an attitude controller and/or the system 200 of FIG. 2, according to examples of the disclosure. The controller 700 includes one or more processor(s) 702, one or more input/output (I/O) interface(s) 704, one or more communication interface(s) 706, one or more storage interface(s) 708, and computer-readable media 710. In examples, the processor(s) 702, I/O interfaces 704, communications interface(s) 706, storage interface(s) 708, and/or computer-readable media 710 may be part of an electronic device or computer system.

In some implementations, the processors(s) 702 may include a central processing unit (CPU), a graphics processing unit (GPU), both CPU and GPU, a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 702 may possess its own local memory, which also may store program modules, program data, and/or one or more operating systems. The one or more processor(s) 702 may include one or more cores.

The one or more input/output (I/O) interface(s) 704 may enable the controller 700 to detect interaction with a human operator. For example, the operator may provide task instructions (e.g., intended flight maneuvers) or monitor metrics (e.g., motor speed, motor torque, etc.).

The network interface(s) 706 may enable the controller 700 to communicate via the one or more network(s). The network interface(s) 706 may include a combination of hardware, software, and/or firmware and may include software drivers for enabling any variety of protocol-based communications, and any variety of wireline and/or wireless ports/antennas. For example, the network interface(s) 706 may comprise one or more of WiFi, cellular radio, a wireless (e.g., IEEE 802.1x-based) interface, a Bluetooth® interface, and the like. Thus, the network interface(s) 706 may enable one or both of the control planes.

The storage interface(s) 708 may enable the processor(s) 702 to interface and exchange data with the computer-readable media 710, as well as any storage device(s) external to the controller 700. The storage interface(s) 708 may further enable access to removable media.

The computer-readable media 710 may include volatile and/or nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, RAID storage systems, or any other medium which can be used to store the desired information and which can be accessed by a computing device. The computer-readable media 710 may be implemented as computer-readable storage media (CRSM), which may be any available physical media accessible by the processor(s) 702 to execute instructions stored on the computer readable media 710. In one basic implementation, CRSM may include random access memory (RAM) and Flash memory. In other implementations, CRSM may include, but is not limited to, read-only memory (ROM), electrically erasable programmable read-only memory (EEPROM), or any other tangible medium which can be used to store the desired information, and which can be accessed by the processor(s) 702. The computer-readable media 710 may have an operating system (OS) and/or a variety of suitable applications stored thereon. The OS, when executed by the processor(s) 702 may enable management of hardware and/or software resources of the controller 700.

Several components such as instruction, data stores, and so forth may be stored within the computer-readable media 710 and configured to execute on the processor(s) 702. The computer readable media 710 may have stored thereon an operating envelope 712. It will be appreciated that the operating envelope 712, may have instructions stored thereon that when executed by the processor(s) 702 may enable various functions pertaining to operating the controller 700, as described herein.

The instructions stored in the operating envelope 712, when executed by the processor(s) 702, may configure the controller 700 to determine an RPM limit when generating modified attitude commands. For example, the controller 700 may determine an airspeed that an aircraft (e.g., aircraft 100) is traveling (e.g., via the sensors 122) and determine an RPM limit based on the operating envelope 712 for a motor of the aircraft that indicates airspeed-based RPM limits that allow for the aircraft to perform maneuvers (e.g., transitioning from vertical to forward flight) without causing unsafe load to be experienced by the aircraft.

The disclosure is described above with reference to block and flow diagrams of systems, methods, apparatuses, and/or computer program products according to the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some examples of the disclosure.

Computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

It will be appreciated that each of the memories and data storage devices described herein can store data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other cases, the databases shown can be integrated or distributed into any number of databases or other data storage devices.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A system for flight control in an aircraft, the system comprising:
a vehicle attitude controller configured to determine one or more commands for a plurality of propulsors, the one or more commands including a command for each propulsor of the plurality of propulsors; and
a mixer configured to:
determine an airspeed associated with the aircraft;
determine an RPM limit associated with the aircraft based at least in part on the airspeed;
calculate adjusted motor commands for the plurality of propulsors based at least in part on the RPM limit; and
transmit the adjusted motor commands to corresponding propulsors of the plurality of propulsors.

2. The system of claim 1, wherein determining the one or more commands comprises:
determining an expected propulsor inertia associated with the command;
determining an additional torque required to overcome the expected propulsor inertia; and
calculating the adjusted motor commands based on the additional torque.

3. The system of claim 1, wherein determining the one or more command comprises:
determining prioritization data associated with the commands; and
calculating the adjusted motor commands based on the prioritization data and the RPM limit.

4. The system of claim 3, wherein calculating the adjusted motor commands based on the prioritization data and the RPM limit comprises:
based on determining that a required RPM associated with the command exceeds the RPM limit, calculating the adjusted motor commands based on the prioritization data.

5. The system of claim 1, wherein the system is further configured to determine prioritization data associated with the commands, wherein the prioritization data determines a priority associated with at least one of:
pitch,
roll,
collective force, or
yaw.

6. The system of claim 1, wherein the mixer is further configured to determine a remaining available RPM value associated with the aircraft based on the RPM limit.

7. The system of claim 1, wherein calculating the adjusted motor commands comprises determining one or more solutions to one or more optimization problems, the one or more optimization problems being associated with the RPM limit.

8. The system of claim 1, further comprising:
determining at least one of an initial vehicle body torque or acceleration;
receiving one or more torque limits associated with the aircraft; and
calculating the adjusted motor commands based at least in part on the at least one of the vehicle body torque or the acceleration, the one or more torque limits, and the RPM limit.

9. The system of claim 1, wherein calculating the adjusted motor commands includes:
determining an output vehicle torque command that does not exceed a predefined limit, wherein the output vehicle torque command is derived in response to determining at least one of an initial vehicle torque or acceleration command exceeds the predefined limit.

10. A system for flight control in an electric aircraft, the system comprising:
a vehicle attitude controller configured to determine at least one of a vehicle body torque or acceleration; and
a mixer configured to:
receive the vehicle body torque or acceleration;
receive airspeed-based RPM limits associated with the electric aircraft; and
determine an adjusted output torque command based at least in part on the airspeed-based RPM limits.

11. The system of claim 10, further comprising determining the airspeed-based RPM limits based at least in part on an operational lift motor envelope.

12. The system of claim 10, wherein the airspeed-based RPM limits include an upper boundary limit that is based on an operational mission including an accelerating transition utilized when transitioning from a hover maneuver to a fixed wing flight maneuver.

13. The system of claim 10, wherein the airspeed-based RPM limits include an upper boundary limit that is based on preventing an inadvertent stall.

14. The system of claim 10, further comprising a first motor and a second motor, wherein the first motor is associated with a first airspeed-based RPM limit and the second motor is associated with a second airspeed-based RPM limit that is different than the first airspeed-based RPM limit.

15. The system of claim 14, wherein the first motor is coupled to a front prop and the second motor is coupled to a rear prop.

16. The system of claim 10, wherein the airspeed-based RPM limits include an upper boundary limit that is based at least in part on a weight of the electric aircraft.

17. The system of claim 10, wherein the airspeed-based RPM limits include an upper boundary limit that is based at least in part on an ambient temperature.

18. A method comprising:
receive at least one of a vehicle body torque or acceleration;
receive airspeed-based RPM limits associated with the vehicle body; and
determine an adjusted output torque command based at least in part on the airspeed-based RPM limits.

19. The method of claim 18, further comprising:
determining an expected propulsor inertia associated with the initial output torque command;
determining an additional torque required to overcome the expected propulsor inertia; and
calculating the adjusted output torque command based on the additional torque.

20. The method of claim 18, further comprising adjusting a propulsor coupled to the vehicle based at least in part on the adjusted output torque command.
